(19) United States
(12) Patent Application Publication
(10) Pub. No.: US 2011/0032849 A1
(43) Pub. Date: Feb. 10, 2011

(54) SYSTEMS AND METHODS FOR MITIGATING INTERFERENCE BETWEEN ACCESS POINTS

(75) Inventors: Simon Yeung, Lei King Wan (HK); Ben Chan, Tseung Kwan O (HK); Jason Leung, Yuen Long (HK); Doug George, Kowloon (HK); Piu Bill Wong, Causeway Bay (HK)

Correspondence Address: FULBRIGHT & JAWORSKI L.L.P, 2200 ROSS AVENUE, SUITE 2800, DALLAS, TX, 75201-2784, US

(73) Assignee: FiMax Technology Limited, Georgetown (KY)

(21) Appl. No.: 12/537,535

(22) Filed: Aug. 7, 2009

(51) Int. Cl. H04B 15/00; H04W 4/00; H04J 3/00

(52) U.S. Cl. 370/280; 370/328; 455/63.1

(57) ABSTRACT

Systems and methods which implement cooperative techniques at wireless network access points to provide interference mitigation are shown. Embodiments utilize cooperative antenna beam adaptation techniques wherein antenna beam selection, selective antenna beam transmission power, and/or antenna beam null selection is implemented based upon the communication environment created by a plurality of access points. Additionally or alternatively, embodiments utilize cooperative antenna beam isolation techniques wherein narrow channel filters are implemented with respect to antenna beam signals and/or shielding is provided between various antenna beams based upon the communication environment created by a plurality of access points. Embodiments additionally or alternatively utilize cooperative antenna beam coordination techniques wherein transmission and/or reception of signals is coordinated, the use of antenna beams is coordinated, and/or interference cancellation is implemented based upon the communication environment created by a plurality of access points.

### CROSS-REFERENCE TO RELATED APPLICATIONS

The present application is related to co-pending and commonly assigned U.S. patent applications Ser. No. 11/842,864 entitled “Adaptive Interference Control,” filed Aug. 21, 2007, Ser. No. 11/770,559 entitled “Systems and Methods Using Antenna Beam Scanning for Improved Communications,” filed Jun. 28, 2007, and Ser. No. 12/470,537 entitled “Multi-Function Wireless Systems and Methods,” filed May 22, 2009, the disclosures of which are hereby incorporated herein by reference.

### TECHNICAL FIELD

The invention relates generally to communications and, more particularly, to mitigating interference between access points, such as where multiple access points are in close proximity or are otherwise disposed to experience interference.

### BACKGROUND OF THE INVENTION

Communication infrastructure has become nearly ubiquitous in developed parts of the world. Both wireline and wireless communication systems are pervasively deployed throughout populous areas. For example, in recent years, wireless communication systems of various configurations, such as for providing mobile voice communication, wireless broadband links etc., have been widely deployed. Often, in order to provide widespread coverage of a service area, such as a metropolitan area or other large geographic area, such wireless communication systems utilize a network of basestations or access points, such as may be deployed in a cellular arrangement.

It is often difficult and expensive to deploy a network of access points in order to provide wireless communication infrastructure to serve a large area. For example, leases or easements must often be obtained from landowners in order to physically deploy an access point. Such leases or easements are not available from many landowners, such as due to the perceived aesthetic impact which may be associated with the deployment of an access point, and are often quite expensive. Therefore, a relatively few physical locations may actually be available for deployment of access points. Moreover, deployment of access points often requires attendant infrastructure, such as towers or other elevated structure for the deployment of antenna systems, fiber optic or other high bandwidth data links for backhaul of data, physical shelter to house transceiver equipment, electric mains to provide necessary power, etc. All this attendant infrastructure adds to the cost and the complexity of deploying access points to provide widespread coverage of a service area.

Communication systems, particularly wireless communication systems, are susceptible to interference, whether in the form of external noise or interfering signals from various stations of the communication systems themselves. For example, wireless networks providing pervasive coverage of a service area, such as the aforementioned cellular wireless networks, typically comprise a plurality of wireless nodes which may radiate signals which interfere with other nodes in close proximity or which are otherwise disposed in the network. Many schemes and protocols have been implemented to facilitate communications despite interference.

Some wireless communication systems, such as global system for mobile communications (GSM), code division multiple access (CDMA) cellular systems, long term evolution (LTE) cellular systems, etc., have implemented frequency division duplexing (FDD) in order to isolate uplink and downlink communications. Although such FDD techniques provide a level of interference mitigation, such techniques require appreciable amounts of spectrum. Specifically, separate frequency bands, possibly having relatively large bandwidths to accommodate desired throughput, separated by a relatively large guard band are required for each of the uplink and the downlink. Such spectrum is often not readily available, such as due to spectrum licensing and/or the available bandwidth of unlicensed frequencies. Accordingly, FDD techniques are not available or practical with respect to some communication system implementations.

Various wireless communication systems, such as IEEE 802.11 (WiFi) wireless networks, IEEE 802.16 (WiMAX) wireless networks, personal handy-phone systems (PHS), etc., have implemented time division duplexing (TDD) schemes in order to utilize the same spectrum in the uplink and downlink. However, in a network system, wherein a plurality of remote terminals are in communication with different access points, transmission by one such node may block reception of other transmissions by another such node. Where the particular nodes are disposed in relatively close proximity, or otherwise have a relatively clear line of sight, such TDD transmissions may block or otherwise substantially interfere with reception of a different channel (e.g., a different frequency channel in a frequency division multiple access (FDMA) TDD system) due to the relative signal levels, the relative proximities, the close spacing of the channels, etc. Accordingly, although providing spectrum efficiencies, systems implementing TDD techniques may suffer from substantial interference as a result of network communications.

Cellular wireless network implementations often utilize channel planning/reuse schemes in order to provide some level of interference mitigation. For example, particular subsets of the FDMA channels from the frequency band utilized by the wireless network are assigned to each access point, such that no FDMA channel is reused by nearby or neighboring access points. The channel reuse factor is (the rate at which the same channel can be used in the network) is often 1/3, 1/4, 1/7, 1/9 and 1/12 (or, according to some notations, 3, 4, 7, 9 and 12 depending on notation), wherein the denominator of the channel reuse factor is the number of cells which cannot use the same channels for transmission. As with the aforementioned FDD, such channel reuse schemes do not use the spectrum efficiently.

### BRIEF SUMMARY OF THE INVENTION

The present invention is directed to systems and methods which implement cooperative techniques at wireless network access points to provide interference mitigation. Embodiments facilitate deployment of a plurality of access points in close proximity, or which are otherwise disposed to experience interference through the use of cooperative antenna beam control. For example, embodiments of the invention utilize cooperative antenna beam adaptation techniques wherein antenna beam selection, selective antenna beam transmission power, and/or antenna beam null selection is implemented based upon the communication environment created by a plurality of access points. Additionally or alternatively, embodiments of the invention utilize cooperative antenna beam isolation techniques wherein narrow channel filters are implemented with respect to antenna beam signals and/or shielding is provided between various antenna beams based upon the communication environment created by a plurality of access points. Embodiments of the invention additionally or alternatively utilize cooperative antenna beam coordination techniques wherein transmission and/or reception of signals is coordinated, the use of antenna beams is coordinated, and/or interference cancellation is implemented based upon the communication environment created by a plurality of access points.

The cooperative antenna beam control techniques of the present invention are particularly well suited for use with respect to TDD communications. Specifically, even where network nodes are disposed in close proximity, such that transmissions in the same frequency band by different nodes would otherwise result in substantial interference, embodiments of the present invention facilitate use of TDD techniques and dense reuse of FDMA channels.

Embodiments of the invention minimize the number of base site locations, thus lowering the total cost of deployment. Through application of the concepts of the present invention a plurality of access points can be put at close proximity in one base site where interference can be mitigated and the total cost of deployment can be lowered.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a wireless communication system adapted according to embodiments of the invention;

FIG. 2 shows a configuration of base site equipment according to embodiments of the invention;

FIG. 3 shows detail with respect to an access point configuration according to embodiments of the invention;

FIG. 4 shows an access point antenna system configuration adapted to provide angular and polarization diversity according to embodiments of the invention;

FIG. 5 shows operation to provide cooperative antenna beam control using cooperative antenna beam adaptation techniques wherein antenna beam selection is implemented based upon the communication environment created by a plurality of access points according to embodiments of the invention;

FIG. 6 shows operation to provide cooperative antenna beam control using cooperative antenna beam adaptation techniques wherein selective antenna beam transmission power is implemented based upon the communication environment created by a plurality of access points according to embodiments of the invention;

FIG. 7 shows operation to provide cooperative antenna beam control using cooperative antenna beam adaptation techniques wherein antenna beam null selection is implemented based upon the communication environment created by a plurality of access points according to embodiments of the invention;

FIG. 8 shows operation to provide cooperative antenna beam isolation techniques wherein shielding between various antenna beams is implemented based upon the communication environment created by a plurality of access points according to embodiments of the invention;

FIG. 9 shows operation to provide cooperative antenna beam coordination techniques wherein transmission and/or reception coordination is implemented based upon the communication environment created by a plurality of access points according to embodiments of the invention;

FIG. 10 shows operation to provide cooperative antenna beam coordination techniques wherein coordinated use of antenna beams is implemented based upon the communication environment created by a plurality of access points according to embodiments of the invention; and

FIG. 11 shows operation to provide cooperative antenna beam coordination techniques wherein interference cancellation is implemented based upon the communication environment created by a plurality of access points according to embodiments of the invention.

### DETAILED DESCRIPTION OF THE INVENTION

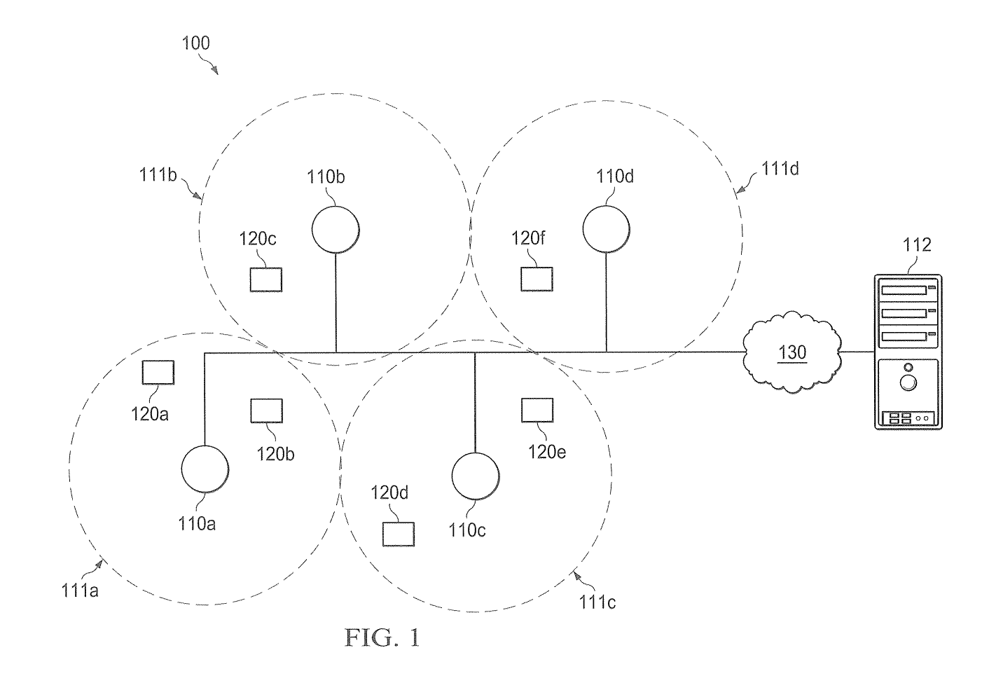

FIG. 1 shows a wireless communication system adapted according to embodiments of the present invention. Specifically, wireless communication system 100 is shown comprising base sites 110a-110d, each having a service area associated therewith (shown as service areas 111a-111d, respectively), and terminals 120a-120f. Each of base sites 110a-110d and terminals 120a-120f are wireless nodes of wireless communication system 100, wherein such wireless nodes may communicate wirelessly with one another. For example, bidirectional links may be provided between a base site of base sites 110a-110d and an associated terminal of terminals 120a-120f to provide broadband communication therebetween. Base sites 110a-110d may, for example, be coupled to various other systems, networks, etc., such as through network 130, to facilitate communication between such systems and networks and terminals 120a-120f. Accordingly, wireless communication system 100 of the illustrated embodiment provides a cellular type wireless network deployment facilitating wireless communication within a service area formed from the aggregate of services areas 111a-111d, wherein service areas 111a-111d provide services to different portions of the aggregate service area (e.g., service areas 111a-111d are substantially non-overlapping although interference between each other may exist).

It should be appreciated that any number of such wireless nodes may be included in a wireless communication system adapted according to embodiments of the invention and thus the concepts discussed herein are not limited to the particular number of base sites and terminals shown. Moreover, various deployment configurations and topologies of wireless nodes may be utilized with respect to wireless communication systems adapted according to the present invention. Accordingly, embodiments of the present invention are not limited to the particular exemplary wireless communication network configuration shown in FIG. 1.

Base sites 110a-110d may comprise various configurations which are adapted to provide wireless communication within a corresponding service area. For example, any of base sites 110a-110d may comprise one or more access points, or other base station transmitter and/or receiver circuitry, adapted to provide wireless communications in accordance with one or more protocols, such as may implement TDD techniques (e.g., WiFi, WiMAX, etc.). Cooperative techniques are preferably implemented with respect to base sites 110a-110d to provide interference mitigation within wireless communication system 100. Such cooperative techniques may be provided under control of controller 112 of the illustrated embodiment. For example, operation of controller 112 may provide cooperative antenna beam control with respect to one or more of base sites 110a-110d, such as to implement cooperative antenna beam adaptation techniques, cooperative antenna beam isolation techniques, and/or cooperative antenna beam coordination techniques according to embodiments of the invention.

Controller 112 of embodiments comprises a processor-based system, such as may include a central processing unit (CPU), memory (e.g., random access memory (RAM), read only memory (ROM), flash memory, magnetic memory, optical memory, etc.), suitable input/output interfaces (e.g., network interface, universal serial bus (USB), serial data line, parallel data interface, video interface, etc.), and an instruction set (e.g., software, firmware, etc.) defining operation as described herein. For example, controller 112 may be provided in the form of a general purpose computer system configured and adapted to provide operation of embodiments described herein. Additionally or alternatively, embodiments of controller 112 may comprise special purpose circuitry, such as application specific integrated circuits (ASICs), programmable gate arrays (PGAs), etc.

Although controller 112 is illustrated in a centralized configuration in FIG. 1, it should be appreciated that different configurations of controller 112 may be utilized according to embodiments of the invention. For example, controller 112 of embodiments may be provided in a distributed configuration, such as through use of multiple separate controllers 112 deployed throughout wireless communication system 100, or otherwise in communication with the base sites thereof. Additionally or alternatively, functionality of controller 112 may be integrated into circuitry of one or more of access points in base sites 110a-110d. For example, particular functionality of controller 112 may be provided by circuitry of access points in base sites 110a-110d while other functionality of controller 112 may be provided by the centralized circuitry illustrated as controller 112 in FIG. 1.

Terminals 120a-120f may comprise any number of different terminal configurations. For example, one or more of terminals 120a-120f may comprise a personal computer (PC), a personal digital assistant (PDA), a cellular phone, a personal handy-phone, a network appliance, or any other device for which wireless communication is to be provided. The terminals may provide wireless communications in accordance with one or more protocols, such as may implement TDD techniques (e.g., WiFi, WiMAX, etc.), corresponding to a protocol utilized by base sites 110a-110d.

Network 130 of the illustrated embodiment may comprise various forms of network infrastructure and configurations, such as a local area network (LAN), a metropolitan area network (MAN), a wide area network (WAN), an intranet, an extranet, the Internet, the public switched telephone network (PSTN), a cable transmission system, a wireless network, a satellite communication system, and/or the like. Network 130 of the illustrated embodiment provides backhaul and/or backbone communication with respect to wireless communication system 100, such as to provide a communication link to networks and systems external thereto. Additionally, network 130 of the illustrated embodiment provides data communication between systems of wireless communication system 100, such as to provide payload data communication (e.g., between various terminals of terminals 120a-120f) and/or control data communication (e.g., between controller 112 and circuitry of base sites 110a-110d and/or between distributed circuitry of controller 112).

As previously mentioned, it is often difficult and expensive to deploy a network of base sites in order to provide wireless communication infrastructure to serve a large area, such as due to leases or easements needed for deploying base sites often being difficult or expensive to obtain and the expense in deploying base site equipment and its attendant infrastructure, such as towers or other elevated structure for the deployment of antenna systems, fiber optic or other high bandwidth data links for backhaul of data, physical shelter to house transceiver equipment, electric mains to provide necessary power, etc. Nevertheless, a plurality of such base sites is often needed to provide adequate coverage of a desired service area. Moreover, the equipment of any one base site is typically limited in the number of terminals it may serve, the amount of data it may carry, the number of links it may support, etc. at any one time. Accordingly, multiple iterations of such equipment often needs to be deployed to facilitate desired communication capacity.

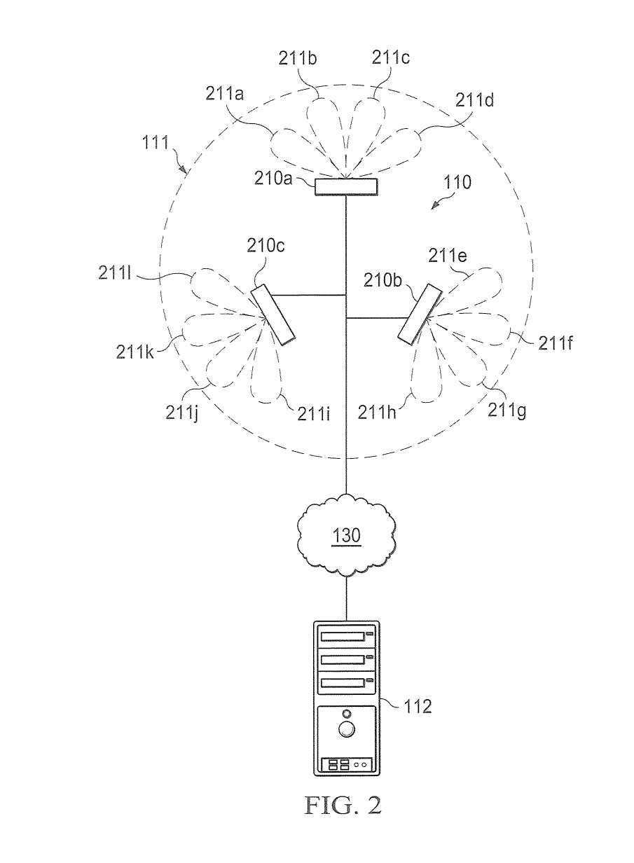

FIG. 2 shows a configuration of base site equipment according to an embodiment of the invention. Specifically, base site 110 (which may correspond to any of base sites 110a-110d of FIG. 1) comprises access points 210a-210c configured to provide wireless communications within service area 111 (which may correspond to any of service areas 111a-111d of FIG. 1). For example, access points 210a-210c may each comprise an access point operable to provide wireless communications in accordance with WiFi protocols, such as by each using a different FDMA channel (e.g., WiFi channels 1, 6, and 11, respectively) within the same operating band. The access points of base site 110 of the illustrated embodiment provides a multiple access point deployment facilitating wireless communication within service area 111 formed from the aggregate of the services areas associated with each access point, wherein the service areas associated with each access point provide services to different portions of service area 111 (e.g., service areas associated with access points 210a-210c are substantially non-overlapping).

It should be appreciated that each of access points 210a-210c of base site 110 are disposed in close proximity to one another. Accordingly, even where different FDMA channels are used with respect to such access points, substantial interference is likely to be experienced. For example, where the base site configuration of FIG. 2 is implemented with respect to base site 110a of FIG. 1, reception of terminal 120a's signal by access point 210a may be blocked by transmission of terminal 120b's signal, although transmitted on a different FDMA channel to access point 120b, because terminal 120a is disposed relatively far away from access point 210a and terminal 120b is disposed very near access point 210a (although being disposed in the service area of access point 210b) and is transmitting on a FDMA channel relatively close in frequency to that used by access point 210a. Similarly, reception of access point 210a's transmission by terminal 120a may be blocked by transmission of access point 210b's signal for the same reasons. It should be appreciated that such interference is not limited to the illustrated embodiment of substantially co-located access points. Other configurations of access points, whether at a same base site or different base sites, may experience similar interference, such as where such access points are deployed relatively nearby with a clear line of sight therebetween.

Accordingly, each of access points 210a-210c of the illustrated embodiments utilizes antenna beam configurations whereby cooperative antenna beam control in accordance with the concepts of the present invention may be implemented. Specifically, the illustrated embodiments of access points 210a-210c comprise multiple antenna beam configurations adapted to provide cooperate antenna beam techniques as described herein.

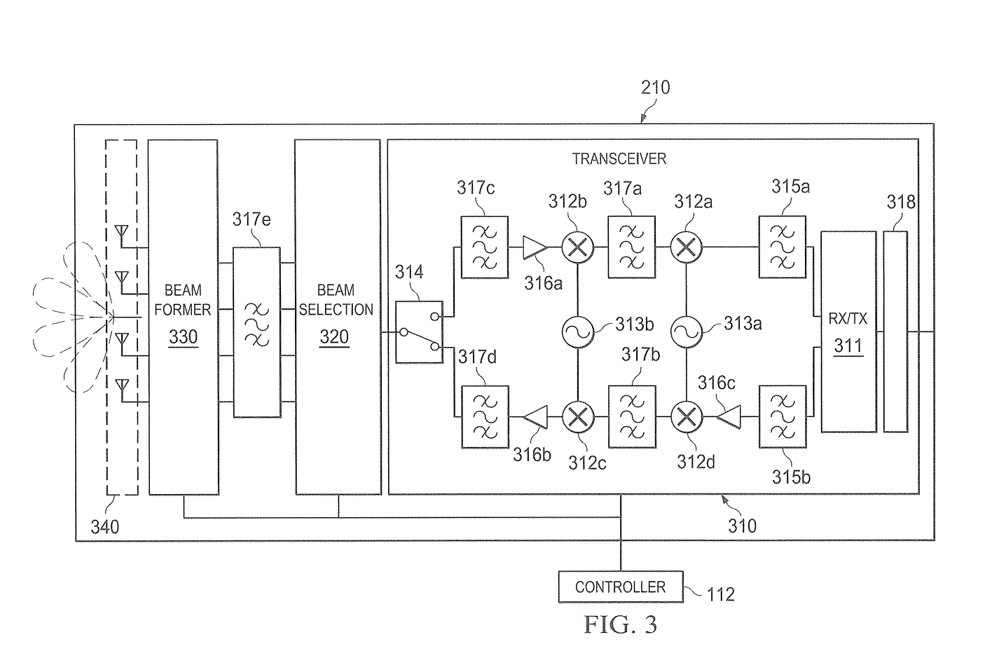

Directing attention to FIG. 3, further detail with respect to an embodiment of an access point configuration according to an embodiment of the invention is shown. Specifically, access point 210 (which may correspond to any of access points 210a-210b) of the embodiment illustrated in FIG. 3 comprises transceiver circuitry 310, beam selection circuitry 320, beamformer circuitry 330, and antenna system 340. Various components of transceiver circuitry 310, beam selection circuitry 320, beamformer circuitry 330, and/or antenna system 340 may operate under control of controller 112 to provide the cooperative antenna beam control herein.

Transceiver circuitry 310 of the illustrated embodiment comprises transmit/receive radio 311 providing modulation and demodulation of signals, mixers 312a-312d and associated local oscillators (LOs) 313a and 313b providing frequency conversion between baseband frequencies, intermediate frequencies, and radio frequencies, and transmit/receive switch 314 providing time division access to the air interface provided by antenna system 340. Signal processing circuitry 318, shown coupled to transmit/receive radio 311, may be utilized to provide desired processing with respect to signals, such as to provide data buffering, protocol conversion, digital to analog and/or analog to digital conversion, interference cancellation, data packet routing, etc.

Transceiver circuitry 310 of the illustrated embodiment further comprises various signal conditioning components, such as baseband filters 315a and 315b and amplifiers 316a-316c, useful in providing desired signal attributes. Channel filters 317a-317e are also shown with respect to the illustrated embodiment of transceiver circuitry 310. As will be discussed in further detail below, channel filters 317a and 317b, 317c and 317d, and 317e each provide an alternative channel filter configuration as may be utilized to implement cooperative antenna beam control by cooperative antenna beam isolation technique according to embodiments of the invention.

Beam selection circuitry 320 may comprise switching circuitry, attenuator circuitry, amplifier circuitry, and/or other circuitry controllable to selectively couple signals between transceiver circuitry 310 and one or more selected antenna beams provided by antenna system 340 and beamformer circuitry 330. For example, a switch matrix may be utilized to provide selective coupling of signals between transceiver circuitry 310 and one or more antenna beam. Additionally or alternatively, variable gain amplifiers associated with each antenna beam may be utilized to selectively provide signals between transceiver circuitry 310 and the antenna beams (e.g., gain of an amplifier associated with a particular antenna beam may be reduced to zero where no signal for that antenna beam is to be coupled to transceiver circuit 310).

Beamformer circuitry 330 may comprise various forms of beamforming networks, such as fixed beam networks, adaptive beam networks, etc. For example, embodiments of the invention utilize a Butler matrix to provide a fixed beam network (e.g., a 4 by 4 Butler matrix to provide 4 fixed antenna beams). Embodiments of the invention may utilize controllable phase shifting and/or signal weighting networks to provide adaptive beam forming for use as described herein. Combinations of the foregoing may be utilized according to embodiments of the invention.

Antenna system 340 may utilize various antenna element configurations, such as patch antenna elements, monopole antenna elements, dipole antenna elements, etc., disposed in a configuration adapted to cooperate with beamformer circuitry 320 to provide desired antenna beams. For example, antenna system 340 may comprise rows and columns of patch antenna elements appropriately spaced such that signals provided thereto from beamformer circuitry 320 constructively and destructively combine in free space when radiated by the antenna elements to define desired antenna beam patterns.

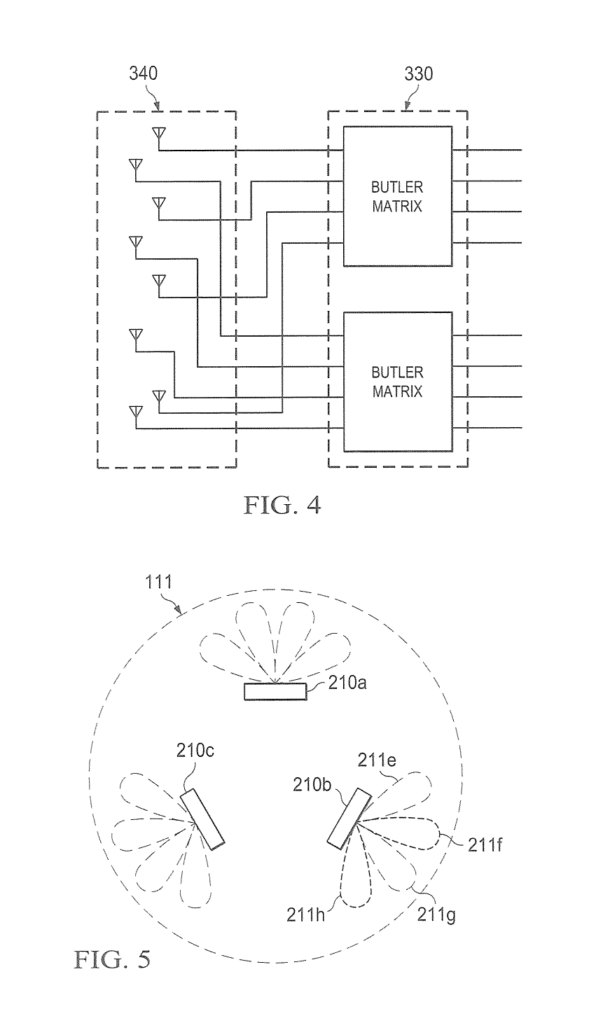

Although shown as providing four substantially identical, angularly diverse, antenna beams, it should be appreciated that antenna system 340 and beamformer circuitry 330 of embodiments may provide any number and configuration of antenna beams. Moreover, various forms of antenna beam diversity may be utilized, such as spatial diversity, polarization diversity, angular diversity, etc. FIG. 4, for example, shows a configuration adapted to provide angular and polarization diversity. Specifically, antenna system 340 of FIG. 4 includes antenna elements having different polarizations (e.g., a sub-system of antenna element rows and columns comprised of antenna elements with slant left polarization and a sub-system of antenna element rows and columns comprised of antenna elements with slant right polarization) coupled to beamformer circuitry 330 providing separate antenna beam signals with respect to the antenna elements of different polarizations.

Referring to FIG. 5, operation of wireless communication system 100 to provide cooperative antenna beam control using cooperative antenna beam adaptation techniques wherein antenna beam selection is implemented based upon the communication environment created by a plurality of access points is shown. Specifically, in the embodiment illustrated in FIG. 5 substantial interference is experienced in antenna beams 211f and 211h of access point 210b and thus controller 112 operates to control beam selection circuitry 320 to deselect those antenna beams for use in transmission and reception by transceiver circuitry 310. Although beams 211f and 211h of the illustrated embodiment are deselected, beams 211e and 211g can remain active for both transmit and receive. Such operation may be particularly desirable with respect to carrier sense multiple access (CSMA) protocols, such as WiFi, to avoid substantial network throughput degradation associated with detection of interfering signal transmission.

For example, transmission by a near by access point, such as access point 210c or an access point of another base site, may provide transmission of a signal effectively blocking reception of signals within one or both of antenna beams 211f and 211h by access point 210b. Similarly, a terminal in communication with another access point, such as access point 210c or an access point of another base site, may provide transmission of a signal effectively blocking reception of signals by access point 210b within one or both of antenna beams 211f and 211h. Accordingly, operation of the illustrated embodiment with respect to access point 210b selects only antenna beams 211e and 211g for transmission and reception by access point 210c, thereby providing adaptation of the portion of service area 111 associated with access point 210b to avoid the interference while continuing to provide wireless communication within at least some parts of that service area portion. Embodiments of the invention may operate to temporarily or partially deselect (e.g., deselect during periods of known or predicted interference, deselect only for transmission or reception, etc., or combinations thereof) as determined to provide desired communication services.

The foregoing selection/deselection of antenna beams provides cooperative antenna beam control wherein antenna beam adaptation allows continued, unimpeded operation of other antenna beams of access point 210b as well as other antenna beams of other access points. In contrast, independent operation of access point 210b to overcome such interference, such as through increasing transmission power, requesting increased transmission power by an interfered terminal, etc., without the cooperative operation described herein, could lead to interference at other antenna beams and other undesired results.

It should be appreciated that the above described embodiment operates to deselect antenna beams 211f and 211h for both transmission and reception operation in order to facilitate service, or higher quality service, with respect terminals disposed within the areas of these antenna beams. That is, if as in the foregoing example reception of signals is effectively blocked with respect to antenna beams 211f and 211h, at least for the periods of interfering transmissions, deselection of the antenna beams for transmission avoids a situation in which a terminal receives a signal transmitted by access point 210b, such as a pilot signal, but the terminal's response or other transmission cannot be received, or fully received, by access point 210b. A terminal within the area of such a deselected antenna beam may thus associate with the access point through another antenna beam (perhaps as a lower data rate), associate with another access point providing at least some level of overlapping coverage, relocate to be disposed within an antenna beam providing adequate service, etc.

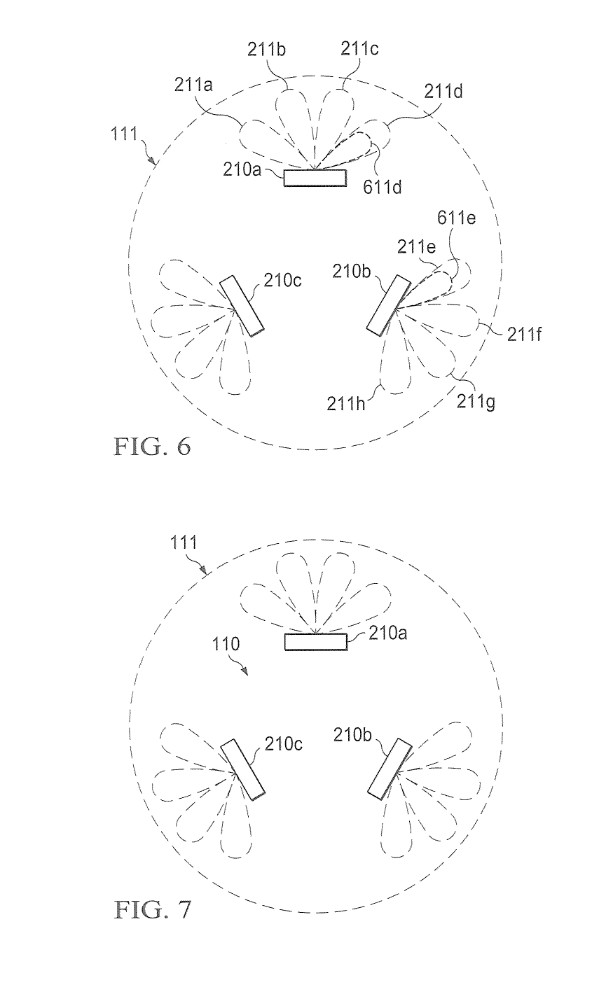

Directing attention now to FIG. 6, operation of wireless communication system 100 to provide cooperative antenna beam control using cooperative antenna beam adaptation techniques wherein selective antenna beam transmission power is implemented based upon the communication environment created by a plurality of access points is shown. Specifically, in the embodiment illustrated in FIG. 6 at least some amount of non-nominal interference is associated with antenna beams 211d of access point 210a and 211e of access point 210b (e.g., these antenna beams may experience interference themselves or be the source of interference with respect to other nodes in the network). Controller 112 operates to control beam selection circuitry 320 to decrease signal transmission power associated with those antenna beams.

For example, interference from antenna beam 211d to antenna beam 211e may be detected. Accordingly, reception of signals transmitted by terminals disposed in one or the other of antenna beams 211d or 211e may be blocked or otherwise substantially interfered. Accordingly, operation of the illustrated embodiment with respect to access point 210a (for antenna beam 211d) and access point 210b (for antenna beam 211e) alters the signal power levels (e.g., increases attenuation provided by a transmit path signal attenuator and/or decreases gain provided by a transmit path variable gain amplifier) associated with antenna beams 211d and 211e, thereby provides adaptation of the portion of service area 111 associated with access points 210a and 210b as shown by resulting antenna beams 611d and 611e. Controller 112 may operate to control attenuator circuitry and/or amplifier circuitry of beam selection circuitry 320 to decrease signal transmission power associated with those antenna beams. Accordingly, interference between resulting antenna beams 611d and 611e is avoided. Such adaptation facilitates interference avoidance while continuing to provide wireless communication within at least some parts of that service area portions. Embodiments of the invention may operate to temporarily or periodically alter selected antenna beams (e.g., during periods of known or predicted interference, during transmission or reception, etc., or combinations thereof) as determined to provide desired communication services.

The foregoing alteration of antenna beam signals provides cooperative antenna beam control wherein antenna beam signal transmission power alteration allows continued, unimpeded operation of other antenna beams of access points 210a and 210b as well as other antenna beams of other access points. In contrast, independent operation of access points 210a and 210b may continue to provide substantial interference with respect to other antenna beams, nodes, etc. within wireless communication network 100. Likewise, independent operation of access points 210a and 210b to overcome interference experienced by these access points themselves, such as through increasing transmission power, requesting increased transmission power by an interfered terminal, etc., without the cooperative operation described herein, could lead to interference at other antenna beams and other undesired results.

It should be appreciated that the above described embodiment operation, reducing the signal transmit level for antenna beams to provide adaptation of service area 111, as shown by antenna beams 611d and 611e, results in modified wireless communications with respect to access points 210a and 210b in both the uplink and downlink according to embodiments. For example, in operation according to embodiments of the invention a terminal disposed within an area of antenna beam 211d or antenna beam 211e which is not included in the area of antenna beam 611d or 611e will not receive signals (or will receive signals at a level below a operational threshold), such as pilot signals, etc., from the corresponding access point and thus will not associate with or otherwise establish an uplink with the access point. A terminal within the area of such an altered antenna beam may thus associate with the access point through another antenna beam (perhaps as a lower data rate), associate with another access point providing at least some level of overlapping coverage, relocate to be disposed within an antenna beam providing adequate services etc. Such operation facilitates improved service, or higher quality service, with respect terminals disposed within the areas of these antenna beams according to embodiments. That is, if reception of signals are substantially interfered with respect to antenna beams 211d and 211e, at least for the periods of interfering transmissions, altering the antenna beams to limit the areas in which terminals are provided wireless communication thereby avoids poor quality service being provided with respect to those terminals. Where the signal of the altered antenna beams, or terminals in communication with the access point via one of the altered antenna beams, is interfering with other antenna beams or other network nodes, altering the antenna beams to limit the areas served by the antenna beams reduces both the interference directly caused by transmission of the antenna beam signal and that associated with transmission by terminals served by the antenna beam,

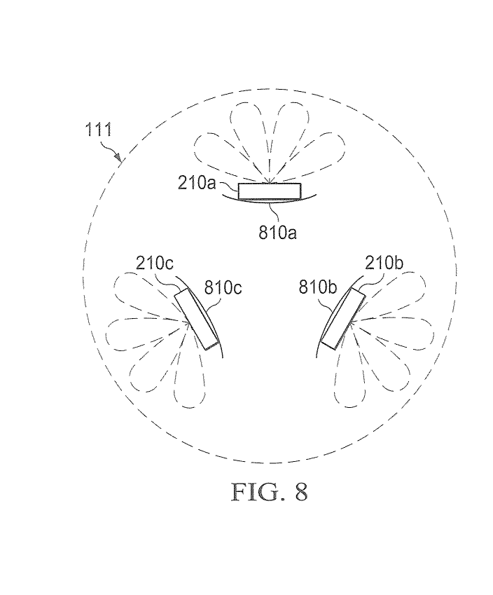

Referring to FIG. 7, operation of wireless communication system 100 to provide cooperative antenna beam control using cooperative antenna beam adaptation techniques wherein antenna beam null selection is implemented based upon the communication environment created by a plurality of access points is shown. Specifically, in the embodiment illustrated in FIG. 7 beamforming technology is used to control the antenna patterns used by an access point without sacrificing the signal quality experienced by terminals in communication therewith. Such embodiments preferably provide antenna beam nulls directed to interfering, or potentially interfering, sources while maintaining desired coverage of a service area or terminals therein.

For example, due to their relatively close proximity, access points 210b and 210c of base site 110 may provide and/or receive at least some amount of non-nominal interference with respect to access point 210a. Accordingly, adaptive beam forming and/or other beam forming techniques are used according to the illustrated embodiment to implement antenna beam nulls for reducing such interference. In accordance with an embodiments when access point 210a transmits, beam former 330 thereof is controlled to form an antenna pattern null towards access points 210b and 210c to reduce power transmitted toward these other access points of base site 110. Additionally or alternatively, in accordance with an embodiment, when access point 210a receives beam former 330 thereof is controlled to form an antenna pattern null towards access points 210b and 210c to reduce interference received from these other access points of base site 110. Controller 112 may control circuitry of beam former 330 (e.g., phase delays and/or weighting associated with particular signal paths) and/or circuitry of beam selection 320 (e.g., attenuation and/or amplification circuitry) to provide one or more null in an appropriate direction.

Embodiments of the invention may implement predetermined or preestablished antenna beam configurations for providing appropriate antenna beam null selection. For example, various known or expected access point deployment arrangements may be accommodated using predetermined antenna beam configurations. According to an exemplary embodiment, access points 210a-210c are adapted for deploying at a same base site to cooperatively provide substantially omni-directional wireless communication services throughout service area 111 using a preestablished triangular deployment scheme upon a tower or other structure. Antenna beam nulling for the antenna systems of each access point is thus provided to steer nulls in the directions of other access points of this base site configuration. It should be appreciated that a plurality of preestablished access point deployment configurations may be provided for using different predetermined antenna beam nulling configurations. Thus, embodiments of the invention may provide a plurality of such configurations for selection of an appropriate one or more such configuration upon deployment or setup of access points in a particular configuration.

Referring again to FIG. 3, operation of wireless communication system 100 to provide cooperative antenna beam control using cooperative antenna beam isolation techniques wherein narrow channel filters are implemented with respect to antenna beam signals is implemented based upon the communication environment created by a plurality of access points will be described. Non-nominal interference from any of a number of sources, including other access points, terminals in communication with other access points, etc., may be experienced by any of the access points of wireless communication network 100. For example, although perhaps utilizing different channels within the communication band at various access points of wireless communication system 100 (e.g., utilizing FDMA channels in a frequency reuse scheme), access points of embodiments of wireless communication network 100 all operate within the same communications frequency band. Accordingly, frequency channels which are relatively close in frequency may be used by nearby (e.g., adjacent) access points. As one example, adjacent access points 210a, 201b, and 210c of base site 110 may utilize WiFi frequency channels 1, 6, and 11, respectively. Moreover, access points of an adjacent base site may reuse these same frequency channels. The relatively near proximity, clear line of sight, etc., in combination with the use of relatively close frequency channels may result in appreciable interference “bleeding” over into the signals received by an access point.

The embodiment illustrated in FIG. 3 includes channel filters 317a-317e of transceiver circuitry 310. Channel filters 317a-317e provide relatively narrow passbands to pass a frequency band of a single channel while substantially rejecting (attenuating) signals outside this passband (e.g., other, even adjacent, channels of the communication frequency band). Channel filters 317a and 317b, 317c and 317d, and 317e of the illustrated embodiment each provide an alternative channel filter configuration as may be utilized to implement cooperative antenna beam control by isolation technique. For example, channel filters 317a-317e may provide 20 MHz band pass bandwidth to provide high adjacent channel rejection for both transmit and receive signals in a wireless communication system using WiFi channels.

An embodiment utilizing channel filter 317e provides a configuration in which a single channel filter performs adjacent channel rejection for both transmit and receive signals. Accordingly, channel filter 317e of embodiments is installed between the antenna system and the antenna ports, prior to receive/transmit signal duplexing. Channel filter 317e is preferably selected to have a passband associated with a frequency channel at which transceiver circuitry 310 is to operate (e.g., a particular WiFi frequency channel the access point is to utilize). For example, the center frequency of channel filter 317e may be selected to correspond to a particular one of channels 1, 6, 11, or other allowable channels within the frequency band, depending upon the frequency channel used by the access point. Selection of the particular center frequency (passband selection) may be accomplished automatically or manually. For example, channel filter 317e may comprise tuning elements allowing the passband to be selected (e.g., by controller 112) in accordance with the particular access point being deployed. Additionally or alternatively, different configurations of channel filter 317e may be provided for selection and installation depending upon the particular access point being deployed. In addition to being selected or adjusted for a particular frequency channel used by the access point, embodiments of channel filter 317e may be provided in weatherproof design or installed in a weatherproof housing, such as to accommodate its deployment near the access point antenna system (e.g., upon an antenna mast, etc.).

An embodiment utilizing channel filters 317c and 317d provides a configuration in which channel filter 317c performs adjacent channel rejection for receive signals and channel filter 317d performs adjacent channel rejection for transmitted signals. Such an embodiment facilitates disposing the channel filters within a same protective housing as other circuitry of transceiver circuitry 310, thereby avoiding costs and materials associated with a weatherproof housing for such filters. As with channel filter 317e discussed above, channel Filters 317c and 317d are preferably selected to have a passband associated with a frequency channel at which transceiver circuitry 310 is to operate (e.g., a particular WiFi frequency channel the access point is to utilize). For example, the center frequency of channel filters 317c and 317d may be selected to correspond to a particular one of channels 1, 6, and 11, depending upon the frequency channel used by the access point. Selection of the particular center frequency (passband selection) may be accomplished automatically or manually. For example, channel filters 317c and 317d may comprise tuning elements allowing the passband to be selected (e.g., under control of controller 112) in accordance with the particular access point being deployed. Additionally or alternatively, different configurations of channel filters 317c and 317d may be provided for selection and installation depending upon the particular access point being deployed.

An embodiment utilizing channel filters 317a and 317b provides a configuration in which channel filter 317a performs adjacent channel rejection for receive signals and channel filter 317b performs adjacent channel rejection for transmitted signals, similar to channel filters 317c and 317d discussed above. Such an embodiment facilitates disposing the channel filters within a same protective housing as other circuitry of transceiver circuitry 310, thereby avoiding costs and materials associated with a weatherproof housing for such filters. Although channel filters 317a and 317b provide a passband adapted to reject channels adjacent to the frequency channel used by the access point, the center frequency of the passband may be independent of the particular frequency channel used. That is, channel filters 317a and 317b are disposed in a portion of transceiver circuitry 310 which is not operating at the wireless transmission radio frequency (here, an intermediate frequency portion of the circuitry). Accordingly, the signals to be filtered are frequency converted (e.g., by mixers 312b and 312d), such that the signal for the channel used by the access point may be disposed within the passband of channel filters 317a and 317b. In such a configuration, a single, fixed passband may be utilized with respect to many different frequency channels by selecting an appropriate amount of frequency conversion through operation of mixers 312b and 312d (e.g., appropriate adjustment of the frequency of LOs 313a and 313b). Selection of the LO frequencies may be accomplished automatically or manually. For example, the LO frequencies may be selected under control of controller 112 or through manual tuning of one or more tuning elements thereof. Although different LOs are illustrated in FIG. 3, embodiments of the invention may combine and use only one LO, such as where the carrier frequency at amplifier 316a output is the same as the carrier frequency at radio transceiver 311 input.

Although embodiments have been discussed above with respect to the use of channel filters in both the transmit and receive signal paths, embodiments of the invention may utilize different configurations with respect to such channel filters. For example, channel filters of embodiments may be provided only in the transmit or receive signal paths, if desired.

Although embodiments have been discussed above with respect to the use of 20 MHz passband in the channel filters 317c, 317d and 317e, embodiments of the invention may utilize different passbands with respect to such channel filters. For example, channel filters of embodiments may use 5, 10 or 40 MHz passband, if desired. Although embodiments have been discussed above with respect to the use of separate channel filters for transmit and receive signals, embodiments of the invention may utilize one filter switched between transmit and receive circuits such as for cost savings.

The filters utilized according to embodiments of the invention may be of various types and configurations. For example, surface acoustic waves (SAW) filters, cavity filters, dieletric filters, etc. may be utilized by embodiments of the invention.

Referring now to FIG. 8, operation of wireless communication system 100 to provide cooperative antenna beam isolation techniques wherein shielding between various antenna beams is implemented based upon the communication environment created by a plurality of access points is shown. Specifically, in the embodiment illustrated in FIG. 8 physical shielding is used to minimize the interference from other antennas of the base site without substantially affecting the signal quality experienced by terminals in communication therewith. The physical shielding of embodiments may comprise reflector panels, Gaussian surfaces, etc. disposed between the antenna elements of an access point and the antenna elements of one or more access points of the base site. Additionally or alternatively, physical shielding utilized according to embodiments may include building structure (e.g., walls, roofs, metallic fences, metallic plates, etc.) disposed between the antennas of access points of a base site. Mounting brackets utilized with respect to the access points of a base site may be adapted to maximize the physical and/or electrical separation between access point antennas of a base site.

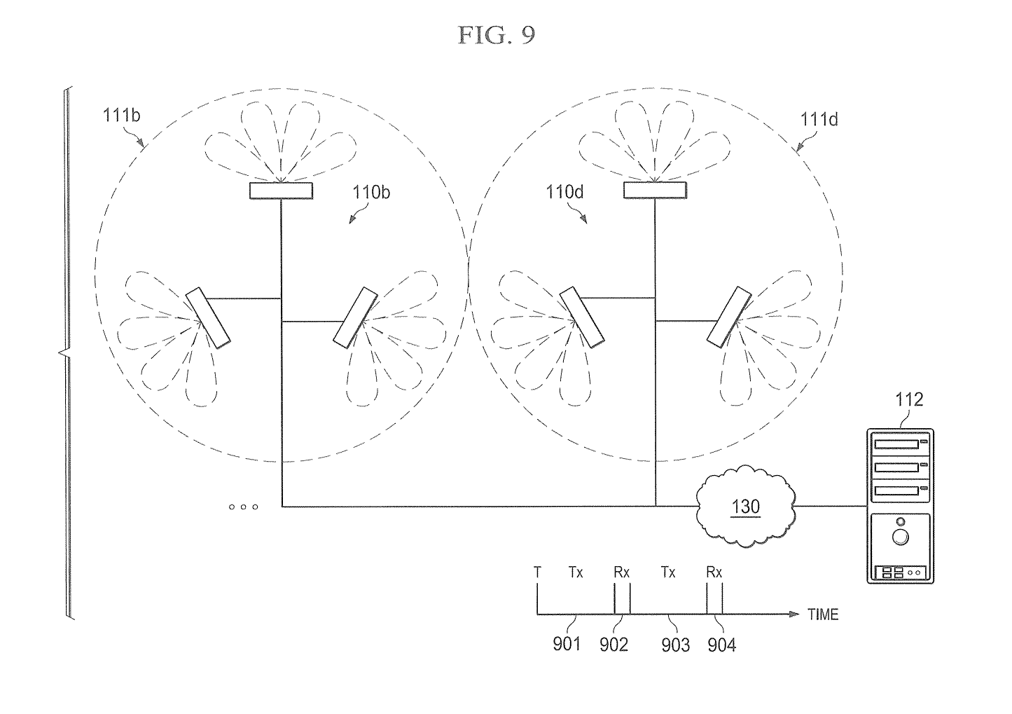

Referring to FIG. 9, operation of wireless communication system 100 to provide cooperative antenna beam coordination techniques wherein transmission and/or reception coordination is implemented based upon the communication environment created by a plurality of access points is shown. Specifically, in the embodiment illustrated in FIG. 9 some or all of the access points of wireless communication system 100 are time-scheduled for simultaneous transmission or simultaneous reception. For example, communication clocks of the access points may be periodically synchronized, for communication time-scheduling. Such synchronization may be accomplished through the use of access point circuitry (e.g., global positioning system (GPS) receivers) facilitating independent or distributed synchronization approach. Additionally or alternatively, such synchronization may be accomplished through the use of a common or centralized time datum (e.g., Internet or remote controller, etc.) to provide a centralized synchronization approach. For example as illustrated in FIG. 9, the access points may be time-scheduled for simultaneous transmission at time slot 901, simultaneous reception at time slot 902, simultaneous transmission at time slot 903, simultaneous reception at time slot 904, and so on.

The foregoing time-scheduled communications for simultaneous transmission and simultaneous reception is implemented with respect to CSMA protocols, such as those of WiFi wireless communications, according to embodiments of the invention. Accordingly, all access points, or selected access points, of a wireless communication network are operated to transmit and receive in synchronization, thus avoiding situations in which an interfering signal from a high power transmission of a nearby access point (e.g., on an adjacent channel or other channel close in frequency) is detected as a carrier. In operation according to the above embodiment, each such access point will transmit in time slot 901 and receive in time slot 902 to avoid their mutual interference causing the medium to be determined to be unavailable under a CSMA protocol due to inter-access point interference. The terminals of wireless communication system 100 may be provided time-scheduled control through the use of CSMA techniques, paging channel transmissions from the access points, etc.

The distribution of transmit time to reception time (i.e., the percentage of transmit time to reception time) may be selected and adjusted based upon various criteria. For example: data transmission associated with typical Internet communications or Internet protocal television (PTV) application may provide for a majority of the communications in the downlink (e.g., 90% access point transmission and 10% access point reception) whereas data transmission associated with remote video surveillance may provide for a majority of the communications in the uplink (e.g., 5% access point transmission and 95% access point reception). Of courses other scenarios may distribute the communications more equally between uplink and downlink (e.g., 50% access point transmission and 50% access point reception), such as digitized voice Communications (e.g., voice over Internet protocol (VoIP) telephone communications). The foregoing distributions of transmit time to reception time may be selected and adjusted through operation of controller 112, to facilitate desired uplink and downlink communications. For examples controller 112 may analyze the communications associated with the access points for which time-scheduled simultaneous transmission and simultaneous reception is to be provided to determine an appropriate distribution. Such analysis may provide blending, averaging, weighted averaging: etc. of the different types of communications then conduced at each such access point to determine a distribution of transmit time to reception time to accommodate the various communications. Additionally or alternatively, the foregoing distributions of transmit time to reception time may be adjusted automatically by operation of controller 112 according to the QoS or ToS tag associated with the application.

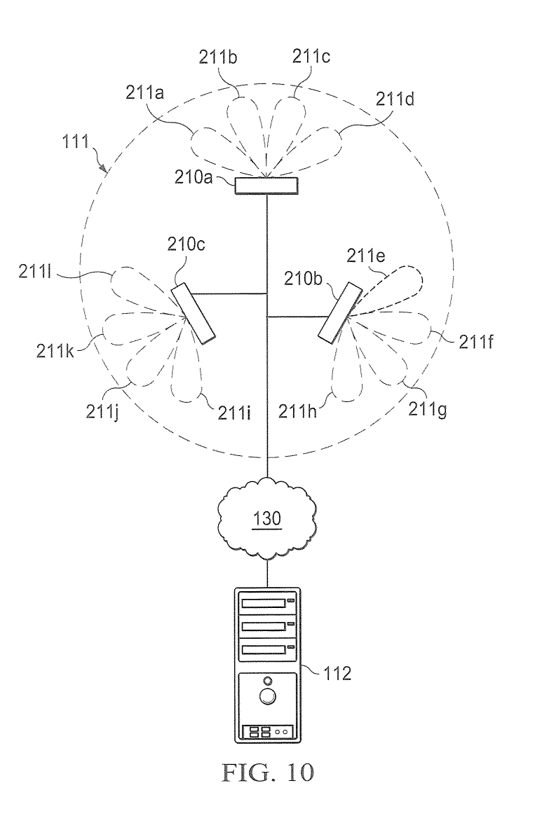

Referring to FIG. 10, operation of wireless communication system 100 to provide cooperative antenna beam coordination techniques wherein coordinated use of antenna beams is implemented based upon the communication environment created by a plurality of access points is shown. Specifically, in the embodiment illustrated in FIG. 10 transmit and receive timing with respect to particular antenna beams is scheduled to avoid interference between antenna beams. For example: communication clocks of the access points may be periodically synchronized (e.g., using global positioning system (GPS) receivers, satellite time transmission, Internet or remote controller, etc.) to provide distributed or centralized synchronization from which antenna beam transmission and reception timing may be coordinated.

For example, in the embodiment illustrated in FIG. 10, it has been determined that transmissions from antenna beam 211e interfere with signals received at antenna beam 211d. Accordingly, use of antenna beam 211e is scheduled, such as through operation of controller 112 controlling beam selection circuitry 320, such that antenna beam 211e does not transmit when antenna beam 211d is used for receiving signals. Accordingly, interference is avoided while service is continued to be provided, at least periodically, throughout the portion of the service area associate with access point 210b.

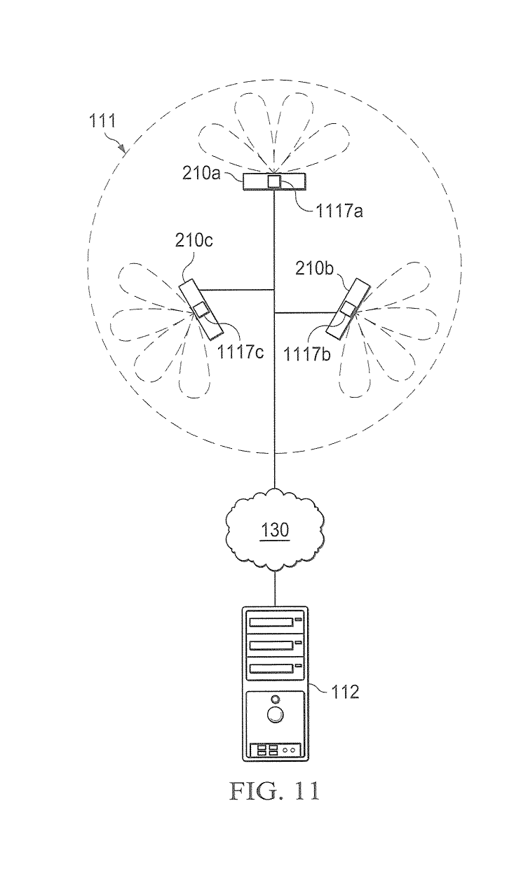

FIG. 11 shows operation of wireless communication system 100 to provide cooperative antenna beam coordination techniques wherein interference cancellation is implemented based upon the communication environment created by a plurality of access points. Specifically in the embodiment illustrated in FIG. 11 interference cancellation circuitry 117a-117c is provided with respect to access points 201a-201c, respectively, for use in processing signals to remove interference components from nearby access points. Such interference cancellation circuitry may be provided as part of signal processing circuitry 318 shown in transceiver circuitry 310 of FIG. 3.

In operation according to an embodiment of the invention, potentially interfering signals from nearby access points (e.g., adjacent access points of a base site) can be known, such as by each access point providing relevant signal transmission information to nearby access points through network 130 under control of controller 112. Such information may comprise the signal transmitted (or to be transmitted) by an access point, the time the signal is (or is to be) transmitted, the particular antenna beams (or other channel information) the signal is (or is to be) transmitted via, etc. Signals received by such nearby access points may use such information to process received signals to remove the now “known” interference components associated with one or more other nearby access points. For example, a received signal may be converted to baseband, digitized, and the digitized signal processed to remove interference components from neighboring access points.

Such cooperative interference cancellation techniques permit very efficient and effective cancellation of the interference components since the particular signal appearing as interference is known. Embodiments of the present invention may additionally or alternatively utilize interference cancellation circuitry to provide cancellation of interference components of an “unknown” nature. For examples interference cancellation circuitry of embodiments may be utilized to cancel a strongest signal appearing within a received signal, such as where a terminal associated with a different access point is disposed more nears or with a more clear line of site, to a particular access point than is a terminal which is associated with that particular access point.

Although particular embodiments have been described above with reference to the various figures it should be appreciated that the concepts of the present invention are not limited to the individual embodiments described. Accordingly, the concepts, features, functions, and structures described herein may be implemented in ways differing than expressly set forth herein in accordance with the present invention. For example, various ones of the foregoing may be implemented in combinations according to embodiments.

One such exemplary embodiment combines cooperative antenna beam control using cooperative antenna beam adaptation techniques, wherein antenna beam selection is implemented based upon the communication environment created by a plurality of access points as discussed with respect to FIG. 5, with cooperative antenna beam coordination techniques, wherein transmission and/or reception coordination is implemented based upon the communication environment created by a plurality of access points as discussed with respect to FIG. 9. Such an embodiment may operate to deselect a particular antenna beam causing interference with one or more other antenna beams during periods when time-scheduled for simultaneous transmission and or simultaneous reception is not used, while utilizing the particular antenna beam during periods when time-scheduled for simultaneous transmission and/or simultaneous reception is used. Accordingly, interference is avoided while wireless communication system 100 is operated to provide communication services throughout the service area.

Another such exemplary embodiment combines cooperative antenna beam control using cooperative antenna beam adaptation techniques, wherein antenna beam null selection is implemented based upon the communication environment created by a plurality of access points as discussed with respect to FIG. 7, with cooperative antenna beam coordination techniques, wherein coordinated use of antenna beams is implemented based upon the communication environment created by a plurality of access points as discussed with respect to FIG. 10. Such an embodiment may operate to use adaptive beam forming technology to steer at least some level of antenna pattern null (or area of decreased signal amplitude) toward a particular antenna beam when beam scheduling will cause an antenna beam that would otherwise interfere with the signal of the particular antenna beam to be selected simultaneously.

There is no limitation to combinations of cooperative techniques herein implementing two such techniques. For example, either or both of the foregoing exemplary embodiments may additionally implement one or more channel filters as discussed with respect to FIG. 3 above.

Various techniques may be utilized to determine interference among particular access points, particular antenna beams, etc. for use in implementing cooperative techniques according to embodiments of the invention. For example, technicians may perform tests and/or modeling to determine interference, or the likelihood thereof, associated with access points, antenna beams, terminals, external sources, etc. Additionally or alternatively, systems of the wireless communication system may operate to perform tests to determine interference, or the likelihood thereof, associated with access points, antenna beams, terminals, external sources, etc.

Setup and provisioning algorithms may be provided with respect to controller 112 in order to determine interference for application of cooperative techniques of the present invention. For example, upon initial deployment of one or more access point, controller 112 may control access points of wireless communication system 100 to scan for interfering signals. For example, each access point may be controlled to transmit a signal, such as its paging signal, through each antenna beam thereof, one at a time. Correspondingly, controller 112 may control other access points of wireless communication system 110, during transmission of the signal by each antenna beam of the above access point, to receive signals through each antenna beam thereof, one at a time. Such transmission and reception of signals may be iteratively repeated with each access point (or each access point of interest) having an occasion to be the transmitting access point, and of course each other access point (or each other access point of interest) monitoring for received signals.

Though analysis of the received signals, the particular access points controller 112 may operate to identify particular antenna beams of the various access points which interact such that interference is, or is likely to, be experienced. For example, where the signal as transmitted using a particular antenna beam of a first access point is received at a threshold power level using a particular antenna beam of a second access point, it may be determined that these two particular antenna beams interfere. Analysis may be performed, such as to determine the particular level of the received signal, the signal to noise ratio of the received signal, etc. to identify one or more cooperative techniques to implement with respect to these two antenna beams in order to avoid or mitigate the interference. Such analysis may include temporarily implementing particular candidate cooperative techniques, such as during repeating of the foregoing transmitting and receiving of paging signals, to analyze their effectiveness with respect to the interference.

The foregoing configuration algorithms may be utilized in determining appropriate cooperative techniques to be employed at times in addition to or in the alternative to during deployment of systems of a wireless communication system. For example, such configuration algorithms may be invoked periodically, such as daily, weekly, monthly, etc. to optimize operation of the wireless communication system for the then prevailing communication environment. An exemplary embodiments invokes such configuration algorithms periodically during periods of little or no wireless network traffic, such as during the very early hours of the day, to minimize impact upon the wireless communication system.

Although embodiments have been described herein with reference to cooperative techniques applied with respect to a plurality of access points disposed in relatively close proximity providing a base site, the concepts of the present invention are applicable to other configurations of access points. For example, cooperative techniques as described above may be applied with respect to access points of different base sites of wireless communication system 100 shown in FIG. 1. It should be appreciated, however, that the cooperative techniques described herein facilitate efficient, reliable operation of access points in very close proximity, such as those used in providing a base site as illustrated in FIG. 2. The cooperative techniques herein are particularly useful in facilitating such multiple access point base sites where the access points utilize relatively close in frequency channels and otherwise rely upon CSMA techniques to facilitate multiple access, such as is the case with access points adapted to operate in accordance with WiFi protocols. For example although using channels which are somewhat prone to interference, and relying upon CSMA techniques to accommodate interfering transmissions, access points adapted to implement cooperative techniques of the present invention allow high channel reuse schemes (e.g., reuse of channels at adjacent base sites, or reuse of 1) while avoiding interference which would otherwise block transmissions in a CSMA system.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
a plurality of wireless network access points disposed to provide an aggregate service area comprised of substantially non-overlapping service area portions associated with each access point of the plurality of wireless network access points; and
control logic in data communication with each access point of the plurality of wireless network access points and operable to control particular access points of the plurality of wireless network access points for cooperative interference mitigation.

2. The system of claim 1, wherein the plurality of wireless network access points are disposed at plurality of base sites.

3. The system of claim 17 wherein the cooperative interference mitigation comprises cooperative antenna beam adaptation implemented with respect to the particular access points under control of the control logic.

4. The system of claim 2, wherein the cooperative antenna beam adaptation comprises antenna beam selection implemented with respect to the particular access points under control of the control logic.

5. The system of claim 2, wherein the cooperative antenna beam adaptation comprises selective antenna beam transmission power implemented with respect to the particular access points under control of the control logic.

6. The system of claim 2, wherein the cooperative antenna beam adaptation comprises antenna beam null selection implemented with respect to the particular access points under control of the control logic.

7. The system of claim 1, wherein the cooperative interference mitigation comprises cooperative antenna beam isolation implemented with respect to the particular access points.

8. The system of claim 6, wherein the cooperative antenna beam isolation comprises narrow channel filters implemented with respect to the particular access points.

9. The system of claim 6, wherein the cooperative antenna beam isolation comprises antenna beam shielding implemented with respect to the particular access points.

10. The system of claim 1, wherein the cooperative interference mitigation comprises cooperative antenna beam coordination implemented with respect to the particular access points.

11. The system of claim 9, wherein the cooperative antenna beam coordination comprises coordinated transmission of signals by the particular access points.

12. The system of claim 9, wherein the cooperative antenna beam coordination comprises coordinated reception of signals by the particular access points.

13. The system of claim 9, wherein the cooperative antenna beam coordination comprises coordinated use of antenna beams by the particular access points.

14. The system of claim 9, wherein the cooperative antenna beam coordination comprises coordinated interference cancellation by the particular access points.

15. The system of claim 1, wherein the control logic comprises:
centralized control logic in communication with one or more access point of the plurality of wireless network access points through a network.

16. The system of claim 1, wherein the control logic comprises:
distributed control logic having at least a portion of the control logic disposed in association with one or more access point of the plurality of wireless network access points.

17. The system of claim 1 wherein the access points of the plurality of wireless network access points comprise wireless local area network access points.

18. The system of claim 1, wherein the access points of the plurality of wireless network access points comprise access points operating in accordance with an IEEE 802.11 communications protocol standard.

19. The system of claim 1 wherein the access points of the plurality of wireless network access points comprise access points implementing a time division duplexing (TDD) scheme.

20. The system of claim 19 wherein the TDD scheme is selected from the group consisting of WiMAX, PHS, and TD-SCHMA.

21. The system of claim 1, wherein the access points of the plurality of wireless network access points each comprise a multi-beam antenna system.

22. A system comprising:
a wireless network base site having a plurality of access points, each of the access points providing wireless communication within a service area of the wireless base site using multiple antenna beams; and
a controller in communication with each access point of the plurality of access points and adapted to control the access points for cooperative interference mitigation using the multiple antenna beams.

23. The system of claim 22, wherein the cooperative interference mitigation comprises antenna beam selection implemented with respect to particular ones of the access points under control of the control logic.

24. The system of claim 19, wherein the cooperative interference mitigation comprises selective antenna beam transmission power implemented with respect to particular ones of the access points under control of the control logic.

25. The system of claim 22, wherein the cooperative interference mitigation comprises antenna beam null selection implemented with respect to particular ones of the access points under control of the control logic.

26. The system of claim 22, wherein the cooperative interference mitigation comprises narrow channel filters implemented with respect to the access points.

27. The system of claim 22, wherein the cooperative interference mitigation comprises antenna beam shielding implemented with respect to the access points.

28. The system of claim 22, wherein the cooperative interference mitigation comprises coordinated transmission of signals by the access points.

29. The system of claim 22, wherein the cooperative interference mitigation comprises coordinated reception of signals by the access points.

30. The system of claim 22, wherein the cooperative interference mitigation comprises coordinated use of antenna beams by particular ones of the access points.

31. The system of claim 22, wherein the cooperative interference mitigation comprises coordinated interference cancellation by particular ones of the access points.

32. The system of claim 22, wherein the access points operate in accordance with an IEEE 802.11 communication protocol standard to provide the wireless communication.

33. The system of claim 22, wherein the access points operate in accordance with a carrier sense multiple access communication protocol.

34. The system of claim 22, wherein the multiple antenna beams provide substantially non-overlapping coverage of the service area.

35. A method comprising:
disposing a plurality of access points to form at least one a base site providing wireless communication within a service area, each access point of the plurality of access points having a multi-beam antenna system for providing the wireless communication within the service area;
selecting a different channel from a wireless communication band of channels for use by each access point of the plurality of access points for providing the wireless communication within the service area; and
controlling access points of the plurality of access points to cooperate to mitigate interference between the access points of the plurality of access points by adjusting one or more parameters associated with antenna beams of the multi-beam antenna system of one or more access points.

36. The method of claim 35, wherein the at least one base site is a plurality of base sites.

37. The method of claim 35, further comprising:
performing a configuration process to determine particular antenna beams associated with different access points of the plurality of access points which interact to case interference.

38. The method of claim 37, wherein the configuration process is performed in association with deployment of one or more access points of the plurality of access points.

39. The method of claim 37, wherein the configuration process is performed periodically during a service life of the plurality of access points.

40. The method of claim 35, further comprising:
using the channel selected for use by an access point for wireless communication within each antenna beam provided by the multi-beam antenna system of that access point.
